(19) United States
(12) Patent Application Publication
(10) Pub. No.: US 2008/0265536 A1
(43) Pub. Date: Oct. 30, 2008

(54) TRANSPORT APPARATUS

(76) Inventor: Shaun Hume, Kent (GB)

Correspondence Address: RYAN, MASON & LEWIS, LLP, 90 FOREST AVENUE, LOCUST VALLEY, NY, 11560, US

(21) Appl. No.: 11/739,193

(22) Filed: Apr. 24, 2007

(51) Int. Cl. B62B 1/00

(52) U.S. Cl. 280/47.23

(57) ABSTRACT

Disclosed are apparatus for transporting articles. Such transporting being, for example, over soft terrain, such as sand, often under controlled temperature conditions.

### FIELD OF THE INVENTION

The present invention is concerned with transport apparatus, and particularly is concerned with apparatus for transporting articles over soft terrain, such as sand, often under controlled temperature conditions.

### BACKGROUND OF THE INVENTION

Some existing transport apparatus include:

U.S. Pat. No. 311,919 discloses a trunk having an outer casing and an inner casing, the inner casing revolving within the outer casing.

GB495,995 discloses a holder including a frame mounted so as to be capable of unlimited rotation, about a horizontal axis and carrying shelves that maintain horizontal positions as the frame is rotated.

GB 539,339 discloses a carrier for conveying supplies, particularly for use in war, comprising a round outer casing and an inner container for the supplies which is mounted in such a way that it may remain upright while the outer casing is rotating.

U.S. Pat. No. 2,903,219 discloses a tilt truck.

GB 2 096 547 discloses a manually operable load-carrying vehicle comprising a hollow synthetic plastic ground wheel of openable construction. The interior of the hollow wheel has a hopper.

GB 2378158 is concerned with a load transporter comprising a first hollow body having a circular cross section, a second hollow body having a circular cross section smaller than that of the first and mounted in the first body on an axis, and a towing handle attached on the outside of the first body. The first outer body is rotatable about said axis relative to and independently of the towing handle and the second body so that first outer body rotates along the ground when a force is applied to the towing handle.

GB 2398292 discloses transport apparatus comprising an outer shell having a circular cross section, a pair of diametrically opposed stub axels fixed on the outer of the shell, a pair of aligned stub axels fixed on the inner surface of the shell, a towing handle freely rotatable on the external stub axels, and a container freely rotatable on the inner stub axels, the outer shell having an upper section which is removable to allow access to the inner container.

WO 2005/070784 is concerned with a container comprising a hollow tubular body, closed at one end and open at the other, and a platform in the body mounted on gimbals to remain horizontal irrespective of the orientation of the body. A towing handle is provided at the closed end of the body.

### SUMMARY OF THE INVENTION

The present invention provides further improvements over existing transport apparatus.

A first aspect of the present invention provides transport apparatus comprising a hollow body; a towing handle; and a container housed within the hollow body, whereby the hollow body is rotatable so as to enable the transport apparatus to be rolled along a surface when a force is applied to the towing handle, the hollow body having two points of contact with the surface, wherein the cross section of the hollow body at the points of contact is circular and the container is mounted on an axis such that it remains upright even when the hollow body is rotating.

The hollow body is rotatable about its axis relative to and independently of the towing handle and the container. Generally, the hollow body will be attached to the towing handle by a gimbal comprising two stub axles on the hollow body and a corresponding recess for each stub axle provided with a bearing on the towing handle, or vice versa. The two stub axles may be provided by a single shaft, where both ends have a corresponding bearing.

The container is a stable carrier for articles while the hollow body provides its means for transportation.

The two points of contact provide increased stability when the transport apparatus is being pulled or pushed using the towing handle as compared with the prior art. The two points of contact further allow the transport apparatus to be moved more easily over soft terrain, such as sand, and also down stairs as compared with transport apparatus known in the art.

Generally, the hollow body is rigid. Any suitable material may be selected. Preferred materials include low density polyethylene and aluminium. A reinforced material such as Kevlar (RTM) may be used.

The outer surface of the hollow body in the region of the points of contact may be curved or substantially flat.

The hollow body generally will comprise a moveable section, which moves to form an opening to allow access to the container housed within. The moveable section may be a detachable lid or movable by rotation (a nesting lid). The moveable section may be secured in a closed position by fastening means.

The moveable section may comprise a handle located on the outside surface in order to assist manual movement of the movable section to form the opening. The handle may also act as a release mechanism for allowing the movable section to be moved. Movement of the moveable section to form an opening may be controlled electronically, possibly remotely.

The hollow body may comprise a first body and a second body joined to form the hollow body; each of the first body and the second body optionally comprising a moveable section. It will be understood that, for ease of manufacture, the first and second bodies themselves may be made from more than one piece. The first body may comprise a first moveable section and the second body may comprise a second moveable section. The first body and the second body preferably each comprise more than half of an ovoid or sphere. Such a dumbbell-type shape is convenient for carrying. The first body and the second body may further each have a flat wall to close the ovoid/sphere or the ovoid/sphere may be open. Preferably, the flat wall is circular. In the transport apparatus, preferably, the flat wall of the first body lies parallel to the flat wall of the second body.

In one embodiment, the first body and the second body each are substantially barrel shaped, with one end comprising a flat wall and the other end comprising an opposing flat wall or being open and a curved wall lying between the two ends. In this embodiment, the towing handle advantageously may be attached to the flat wall of the first body and the flat wall of the second body. The attachment generally will be by means of a stub axle. The towing handle advantageously may comprise a U-shaped portion, which is attached to the first and second bodies and an elongated portion, which extends from the U-shaped portion. The elongated portion may be detachable. The elongated portion may comprise a handle portion, for grasping to pull or push the transport apparatus. When the elongated portion is detached, the U-shaped portion may act as a carrying handle.

The hollow body preferably is symmetrical about a plane lying half way between the first point of contact and the second point of contact. In this case, the hollow body may be considered to comprise a first half and a second half. The first half may comprise the first body and the second half may comprise the second body. In this case, where the hollow body comprises a first body and a second body, the first body preferably is the mirror image of the second body.

The first body may be joined to the second body via a central member, in which case the hollow body comprises the first body, the second body and the central member. This elongated shape of the hollow body provides more storage space inside the hollow body than a spherical hollow body. Further, it will be appreciated that in order to achieve the same internal volume, a smaller diameter circle can be used for the first and second bodies as compared with a spherical hollow body.

The central member may be substantially tubular, with the first body joined to one end of the tube and the second body joined to the other end. The central member may comprise jockey wheels with which the first body and second body are in contact to enable rotation of the first and second bodies. The jockey wheels generally will be arranged in two sets around the circumference of the two circular ends of the substantially tubular central member, to be in contact with the flat wall of the first body and the flat wall of the second body. The jockey wheels allow the first body to rotate independently of the second body. This enhances manoeuvrability and turning ability of the transport apparatus.

The outer surface of the flat wall of the first body preferably engages with a first set of jockey wheels of the central member, which enable the first body to rotate. The outer surface of the flat wall of the second body preferably engages with a second set of jockey wheels of the central member, which enable the second body to rotate.

In one embodiment, the hollow defined by the walls of the hollow body is a single storage area, which maximises the storage capacity of the container housed within the hollow body. In this embodiment, the transport apparatus generally will include a single container in the single storage area of the hollow body.

In another embodiment, the hollow defined by the walls of the hollow body may be divided into more than one storage area, preferably two, equal sized storage areas. In this embodiment, the transport apparatus generally will include a first container and a second container, each housed respectively in a first and second storage area of the hollow body. Advantageously, there may be a first temperature in the first storage area and a second, different temperature in the second storage area, so that the first container may be stored under different controlled temperature conditions to the second container.

In this embodiment, the hollow body may comprise a first hollow body defining a first storage area and comprising an ovoid or sphere closed by a first flat wall and a second hollow body defining a second storage area and comprising an ovoid or sphere closed by a second flat wall. Thus the first storage area generally will be defined by the first body and the second storage area generally will be defined by the second body.

Access to the container housed within the hollow body via the moveable section may be by any suitable means. For example, the moveable section may comprise a lid that is removable to provide access to the inside of the body. Such a lid is described in GB 2398292. The lid may be completely removable from the remainder of the hollow body. Alternatively, the lid may be moveably, for example rotatably, mounted onto the remainder of the hollow body and may be moved between a first open position and a second closed position. This is known in the art as a nesting lid. Such a lid is described in GB 2378158. Nesting lids preferably are provided in the case of transport apparatus having first and second storage areas.

In one embodiment, the container is accessed from the side of the hollow body. In another embodiment, the container is accessed from the top of the hollow body

According to one embodiment, one end of the container comprises the moveable section and the moveable section is located on the side of the hollow body. The hollow body preferably defines a single storage area in this embodiment. In this embodiment, the base of the container preferably is substantially flat and is provided with a jockey wheel. A guiding wall is provided inside the hollow body across which the jockey wheel rolls when the container is inserted inside the hollow body. The guiding wall is of a suitable length and gradient so that when the container is fully inserted inside the hollow body, the jockey wheel lies adjacent to and beyond the end of the guiding wall and the base of the container is above the guiding wall and is not in contact with the guiding wall. When the container is in this fully inserted position, a stub axle for mounting the container to the hollow body may be provided so that it extends from the leading edge of the container and engages with a corresponding hole provided with a bearing in the hollow body. The stub axle enables gravity to keep the container in its upright position. It will be understood that, in this embodiment, the action of the container is similar to that of a draw.

The guiding wall may be considered as a ramp for the jockey wheel(s).

In the case of the moveable section being on the side of the hollow body, the container may comprise the moveable section. This is particularly useful when the action of the container is similar to that of a draw. The moveable section must be attached to the container so that the moveable section rotates as part of the hollow body when the transport apparatus is rolling, whilst the container remains upright. To this end, the moveable section may be permanently attached to the end of the container via a stub axle extending from the end of the container into a corresponding recess provided with a bearing on the moveable section.

In the case of a hollow body having a first body and a second body as described above, the first body may house a first container and the second body may house a second container. Each of the first container and second container may be accessed from the side of the respective first and second bodies, preferably by means of a nesting lid.

A first preferred embodiment of the first aspect of the invention is characterised in that the towing handle is mounted to the central member, between the first body and the second body, and the towing handle is extendable telescopically between a first extended position for pulling or pushing the transport apparatus and a second folded position for carrying or storing the apparatus.

Preferably, the towing handle comprises a handle portion, a first hollow member having a first cross section and a second hollow member having a second cross section that is smaller than the first cross section. Further hollow members may be provided of increasingly smaller cross section. The hollow members are mounted with the largest cross section member at least partially within the hollow body such that in the folded position, all of the hollow members are housed within the first hollow member and the handle portion is visible at the end of the first hollow member. The handle portion is mounted to the end of the tube of the smallest cross section. This assembly commonly is known as “telescopic”. The first hollow member acts as a connecting housing for connecting the towing handle to the hollow body.

The towing handle preferably has a two stub axles extending from it at a point where the towing handle is within the hollow body: one into a recess in the flat wall of the first body and one into a recess in the flat wall of the second body, each recess being provided with a bearing. The first and second hollow bodies rotate about these stub axles. A single shaft may comprise the two stub axles.

The first embodiment of the first aspect of present invention is particularly desirable when the transport apparatus comprises first and second storage areas, for example as described above since the first hollow body can be mounted between the first and second flat walls for the first and second hollow bodies.

A second preferred embodiment of the first aspect of the present invention is characterised in that the towing handle is moveable between a first extended position for pulling or pushing the transport apparatus and a second folded position for carrying or storing the apparatus, wherein the towing handle comprises a rigid, curved portion and a handle portion, wherein one end of the curved portion is attached to the central member and the handle portion is fixed to the other end of the curved portion. The shape of the curved portion preferably comprises part of a circle, more preferably a semicircle. When the towing handle is in the second folded position, the curved portion wraps around the central member. When the towing handle is in the first extended position, the curved portion extends from the hollow body. The handle portion may be integral with the curved portion.

The means for attaching the curved portion of the handle to the central member may comprise a tubular portion, which forms an wall around the outside of the central member. In this case, the hollow body, including the central member will be able to rotate whilst the tubular portion around the central member remains stationary relative to the central member. This rotation may be enabled by bearings located between and in contact with the tubular portion and the central member. The area between the tubular portion and the central member may be sealed from the outside so that dirt etc cannot enter during use. Alternatively, the area between the tubular portion and the central member may be open to the outside. In this case, it may be advantageous to provide cleaning means for the bearings, such as nylon brushes.

The second embodiment of the first aspect of present invention is particularly desirable when the transport apparatus comprises a single storage area, for example as described above.

The towing handle as described anywhere herein may act as a further point of contact on a surface on which the transport apparatus may rest in order to further stabilise the apparatus when the towing handle is in the extended position.

A second aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that absorbing material is provided on the outer surface of the hollow body at the or each point of contact. The purpose of the absorbing material is to provide impact and sound absorption when the transport apparatus is rolling over hard terrain. The material radiates from the point(s) of ground contact of the hollow body.

The surface of the absorbing material may be raised as compared with the surface of the hollow body. Alternatively, the surface of the absorbing material may be flush with the surface of the hollow body. In this case, the hollow body must define a recess to accommodate the absorbing material. Even when the surface of the absorbing material is raised as compared with the surface of the hollow body, the hollow body may define a recess to accommodate a certain thickness of the absorbing material. The recess provides a means for maximising the total thickness of absorbing material.

The absorbing material may be provided as a single, continuous layer, preferably having a ribbed surface. The single, continuous layer of absorbing material for sound and shock absorption preferably comprises rubber.

Alternatively, the absorbing material may be provided in the form of a plurality of, preferably polypropylene, hollow tubes on the outer surface of the hollow body.

In one preferred embodiment of the second aspect of the invention, the transport apparatus has a single point of ground contact and the hollow body is substantially spherical. Preferably the transport apparatus has a single storage area defined by the hollow body. The hollow body may comprise first and second bodies each being substantially hemispherical, the first and second bodies being joined by a central member that is substantially tubular. Thus, the transport apparatus will be substantially flat in the region of the point of contact. In this embodiment, the hollow body preferably has a single moveable section in the form of a removable lid. Further, the towing handle preferably is attached to the side, more preferably to both sides, of the hollow body. Each attachment of the handle to the hollow body preferably comprises a stub axle and bearing so that the hollow body is free to rotate without the handle.

A third aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the towing handle is provided with a control for a brake, wherein when the control is activated the brake is disengaged and the hollow body is free to rotate and when control is not activated the brake is engaged and the hollow body is prevented from rotating.

Preferably, the brake is a so-called active brake where pressure must be applied to the control at all times in order for the brake to be disengaged; the default position of the control (when no pressure is applied) being that the brake is engaged. The brake thus prevents the transport apparatus from unintentional rolling. If a user unintentionally lets go of the towing handle whilst the apparatus is on a gradient, the brake will engage and the transport apparatus will come to a rest with the towing handle resting on the ground.

The brake may comprise brake pads or may comprise one or more locking pins. A brake comprising brake pads has an advantage in being a progressive brake. If the control is released unintentionally, the brake pads will engage to bring the transport apparatus progressively to a stop.

The third aspect of the present invention is particularly useful with transport apparatus having a telescopic towing handle according to the first preferred embodiment of the first aspect of the present invention. For example, when the brake comprises one or more locking pins, the brake may comprise a first locking pin and a second locking pin, the first and second locking pins being moveable together between a first position and a second position. In the first position, the first and second locking pins are substantially housed within the first hollow member. In the second position, the first and second locking pins extend from the first hollow member and the first locking pin engages with a hole in the flat wall of the first body and the second locking pin engages with a hole in the flat wall of the second body so as to prevent the rotation of the first body and the second body. The locking pins are moveable between the first and second positions by means of a control located on the towing handle portion of the towing handle. When pressure is applied to the control, this causes wires or rods, for example, that connect the control to the first and second pins to move the locking pins into the first hollow member to the first position. When pressure is released from the control, the locking pins move back to the second position. It will be understood that when the towing handle is in the folded position with the second and further hollow members located within the first hollow member, this also causes the locking pins to move to the second locked position.

A fourth aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the apparatus is further provided with legs moveable between a first position and a second position. When the legs are in the first position, they are held within the hollow body and do not interfere with the ability of the hollow body to rotate and the transport apparatus to roll along the ground. When the legs are in the second position, they extend from the hollow body to provide additional points of contact with the surface on which the transport apparatus is resting.

The legs may be placed in any suitable location. Preferably there are two legs. In the case of a hollow body having one point of contact with the surface on which it is resting, it is preferred that the first and second legs are equidistant from the point of contact, with the legs being on opposite sides of the point of contact. In the case of a hollow body having two points of contact with a surface on which it is resting, it is preferred that the first leg is positioned in line with the first point of contact or between the first and second points of contacts at some distance from the first point of contact. Preferably, the second leg is located in line with the second point of contact or between the first and second points of contact at some distance from the second point of contact. The first and second legs should not alter the symmetry of the hollow body. Thus, the second leg should be the same distance from the second point of contact as the first leg is from the first point of contact.

The legs preferably are located on the opposite side of the hollow body to the handle portion of the towing handle.

The towing handle may control the legs. In this embodiment, the legs preferably are integral with the towing handle.

A fifth aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the hollow body comprises an inner wall and an outer wall. The cavity between the inner wall and the outer wall may be filled with a suitable insulating material such as fiberglass, for example. The outer wall will rotate as one with the inner wall.

Any reference herein to the inner or outer surface of the hollow body may be taken to mean the inner or outer surface of the hollow body in the case of a hollow body having a single wall and the inner surface of the inner wall and the outer surface of the outer wall in the case of a hollow body having an inner wall and an outer wall.

The inner wall of the hollow body may comprise the guiding wall described above in relation to the first aspect of the invention.

A sixth aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the outer surface of the hollow body is uneven in the region of the one or two points of contact. This imparts further rigidity to the hollow body.

Preferably, the uneven surface is a corrugated surface. The plurality of hollow tubes disclosed in relation to the second aspect of the invention advantageously may be provided in the grooves of the corrugated surface.

A seventh aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the towing handle comprises a substantially U-shaped portion, which is attached at its two ends to the hollow body, and an elongated portion, which extends from the U-shaped portion, the elongated portion being detachable from the U-shaped portion and comprising a handle portion for grasping to pull or push the transport apparatus.

It will be understood that the U shaped portion will be attached to the hollow body so that the hollow body is able to rotate without the U-shaped portion.

Preferably, the U-shaped portion is shaped such that, when the elongated portion is detached, the U-shaped portion acts as a carrying handle for the transport apparatus.

In all aspects of the present invention, it is preferred that any external mating edges in the transport apparatus, for example the edges of the moveable section(s), are provided with a water tight and/or air tight seal. This will enable the transport apparatus to float in water. When the transport apparatus is air tight, it may be possible to provide the apparatus with means such as a pump to remove the air from the container to create a vacuum therein. This enables the inside of the hollow body to be a controlled e.g. sterile environment.

Thus an eighth aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that all external mating edges in the transport apparatus are provided with a seal so as to render the transport apparatus air tight and/or water tight.

In all aspects, the transport apparatus may be provided with a mud guard, optionally attached to the towing handle, to protect the user during carrying from mud, dirt etc which may have accumulated on the transport apparatus as it rolls along the ground.

In all aspects, the transport apparatus may be provided with a wiper, optionally attached to the afore-mentioned mud guard, to remove mud, dirt etc which may accumulate on the transport apparatus as it rolls along the ground.

In all aspects of the present invention, the container preferably is in the shape of a high-sided cradle. The cross section of the cradle may be curved. Alternatively, the cradle may have a flat base and curved sides. The opposing ends of the cradle preferably are shaped to follow the shape of the hollow body, in order to maximize the space within the container.

The container may be fixed or may be capable of moving at least partially out of the hollow body.

The container may or may not be removable from the hollow body.

The container may be freely rotatable about its axis so that as the hollow body is rolled along the ground or other surface the container the container is self locating and remains upright. The container generally will be rotatable about its axis independently of the towing handle. The container remains upright irrespective of the orientation of the hollow body.

The container generally will be open-topped to aid self-location under the force of gravity. However, the container may have a lid if it is desirable. A lid can help to ensure that the container is not overloaded. The lid can also provide a further layer of insulation (in addition to the air gap between the container and the hollow body and the optional double wall of the hollow body) for the contents of the container.

The container may have a bias weight attached to it.

A ninth aspect of the present invention provides transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the container comprises a plurality if sub-containers specifically adapted to fit together so as to be suitable to be housed inside the hollow body and wherein the container is provided with a pair of opposing stub axles or a pair of opposing recesses or one stub axle and one opposing recess so as to be suitable to be mounted on an axis such that the container remains upright even when the hollow body is rotating.

In one embodiment, the sub-containers fit together within a basket, such as a wire mesh basket, to form the complete container. In this case, the basket may comprise the pair of stub axles or pair of recesses or one stub axle and one recess.

The sub-containers provide separate compartments within the container.

It will be understood that the features of the transport apparatus according to the one aspect may be combined with the features of the transport apparatus according to the other aspects of the invention.

The transport apparatus according to the present invention is envisaged to be useful to transport items that are sensitive to motion or to temperature or other conditions, for example food and drink; pressurised liquids, for example carbonated drinks; medical supplies; biological materials; hazardous materials; and explosive items, for example landmines. The container being housed within the hollow body effectively may be used to seal the contents from the outside, whilst also keeping the contents upright. The dimensions of the transport apparatus may be suitable selected according to its intended use.

### BRIEF DESCRIPTION OF THE DRAWINGS

The present invention now will be provided with reference to the attached Figures in which:

FIGS. 1 (a) to (i) show possible shapes for the hollow body for transport apparatus according to the first aspect of the invention;

FIG. 2 shows an exploded view of one half of a hollow body for transport apparatus according to the first aspect of the invention;

FIG. 3 shows the cavity for shock and sound absorbing material for transport apparatus according to the second aspect of the invention;

FIG. 4 shows the pins of the lock and the first hollow member for transport apparatus according to the fifth aspect of the invention;

FIG. 5 shows an exploded view of the towing handle and legs for transport apparatus according to the third and sixth aspects of the invention;

FIGS. 6 (a) and (b) show a front view of a section of the telescopic towing handle according to the third aspect of the invention, with the second and third hollow members in their extended positions and the first hollow member in its folded position in FIG. 6(a).

FIGS. 7 (a) and (b) show a front view of a section of the towing handle from FIG. 6, with the first hollow member also partially in its extended position. FIG. 7 (c) shows the perspective view of the towing handle of FIGS. 7(a) and (b).

FIGS. 8 (a) and (b) show a front view of a section of the towing handle from FIG. 6, with the first hollow member also in its extended position.

FIG. 9 shows the control for the lock of a transport apparatus according to the fifth aspect of the invention;

FIG. 10 shows transport apparatus according to the ninth aspect of the invention;

FIG. 11 shows container in the shape of a cradle for transport apparatus according to the seventh aspect of the invention;

FIG. 12 shows one embodiment of transport apparatus having a single point of contact according to the invention.

FIG. 13 shows one embodiment of transport apparatus having two points of contact and one storage area according to the invention.

FIG. 14 shows an exploded view of the transport apparatus of FIG. 13.

FIG. 15 shows the transport apparatus of FIG. 15 with the container fully inserted and fully removed from the hollow body.

FIG. 16 shows one embodiment of transport apparatus having two points of contact and two storage areas according to the invention.

FIG. 17 shows a cross section of the transport apparatus of FIG. 16.

FIG. 18 shows a perspective view of the transport apparatus of FIG. 16.

FIG. 19 shows a cross section of parts of the transport apparatus of FIG. 16, including the towing handle.

FIG. 20 shows a perspective view of the central member of the transport apparatus of FIG. 16.

FIG. 21 shows a perspective view of transport apparatus having a towing handle comprising a U-shaped portion and an elongated portion.

FIG. 22 shows the transport apparatus of FIG. 21, with the lid in the open position to provide access to the inside.

### DETAILED DESCRIPTION OF PREFERRED EMBODIMENTS

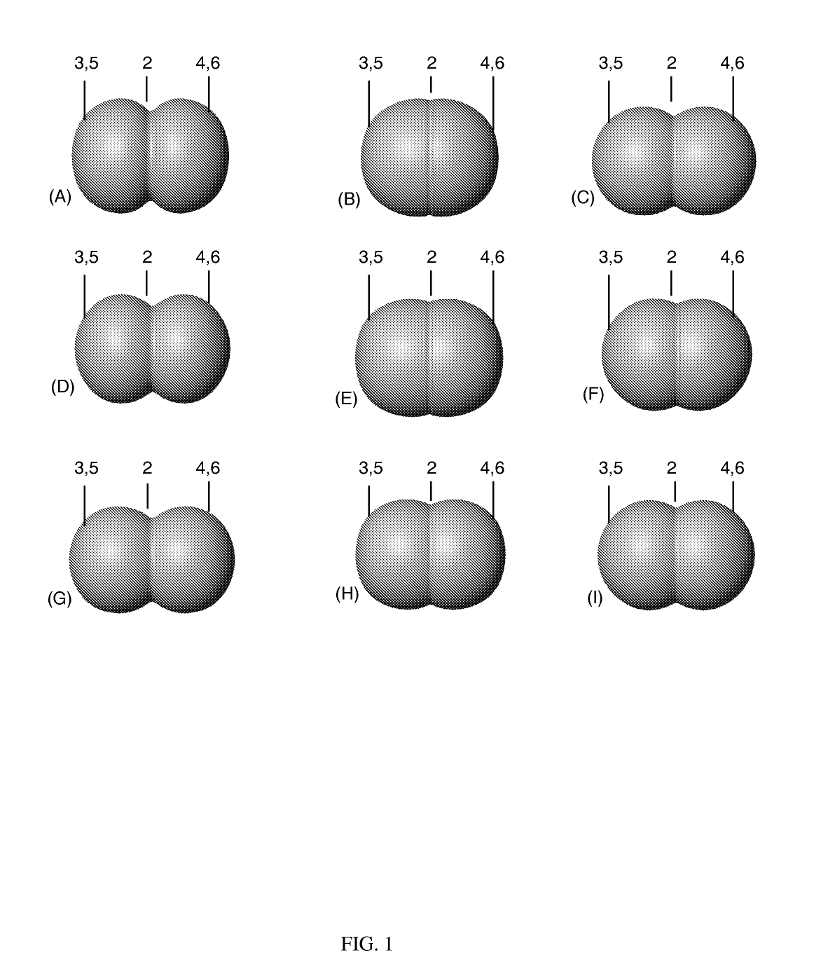

In FIG. 1, the two halves (3,4) of the hollow bodies (2) may be provided as a first body (5) and second body (6) or as a single body.

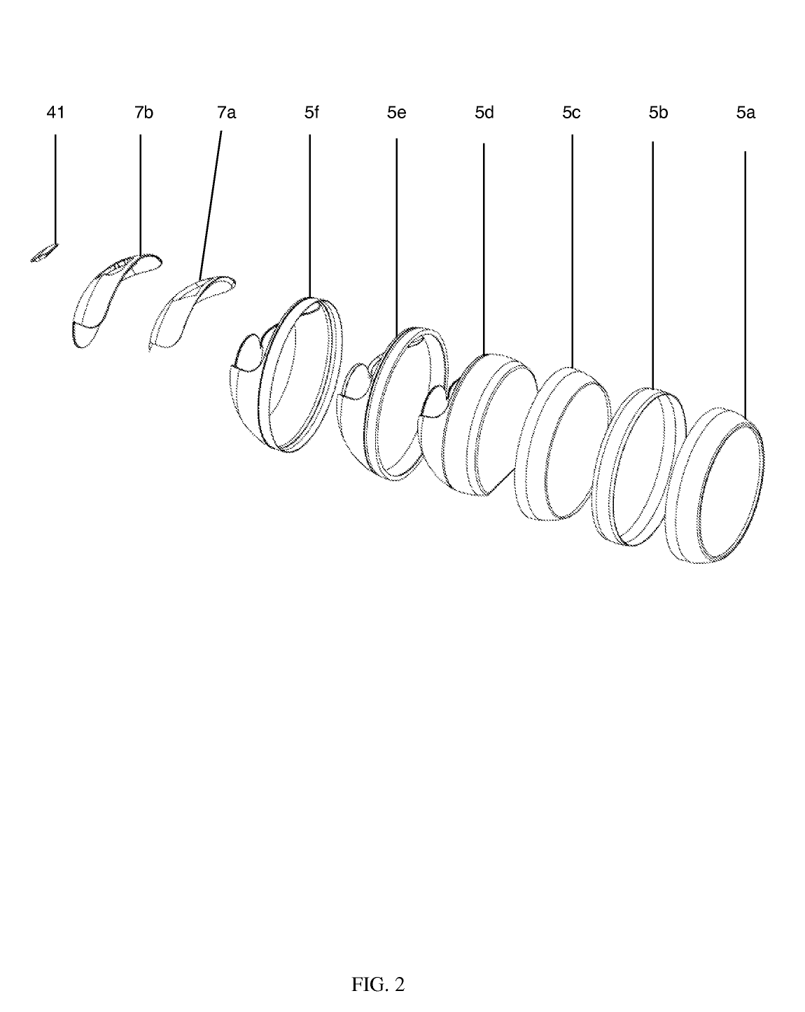

In FIG. 2, the first body (5) is made up of parts 5a/b/c/d/e/f; the moveable portion (7) is made up of parts 7a/b. The handle (41) is shown.

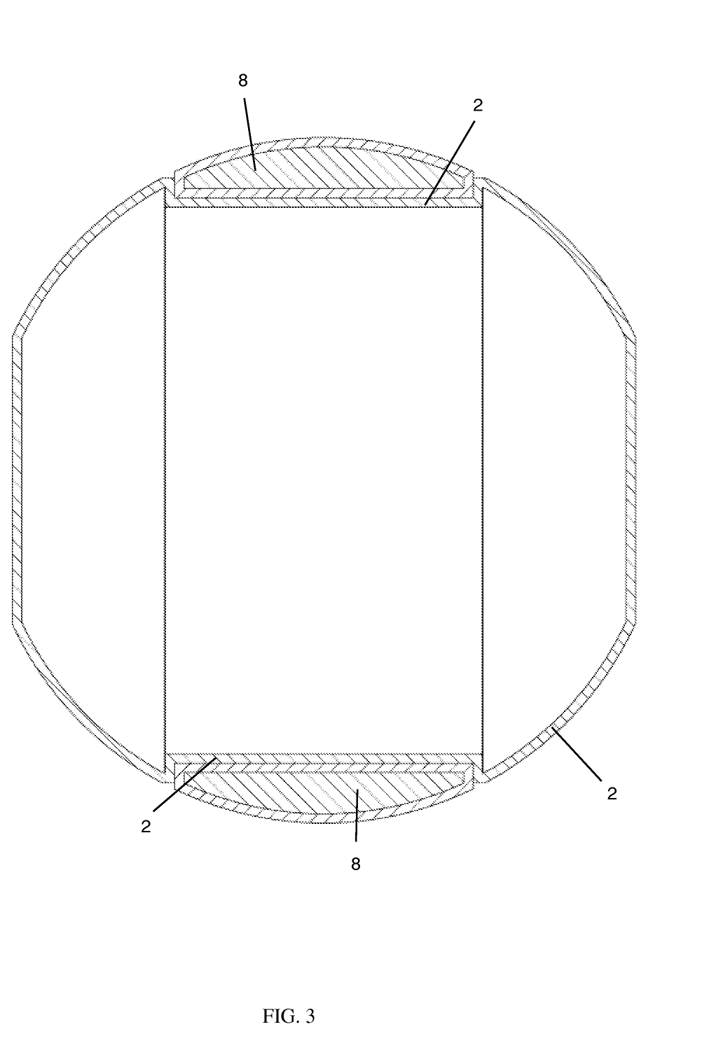

In FIG. 3, the cavity (8) for the shock and sound absorbing material is located between the inner wall (9) and the hollow body (2).

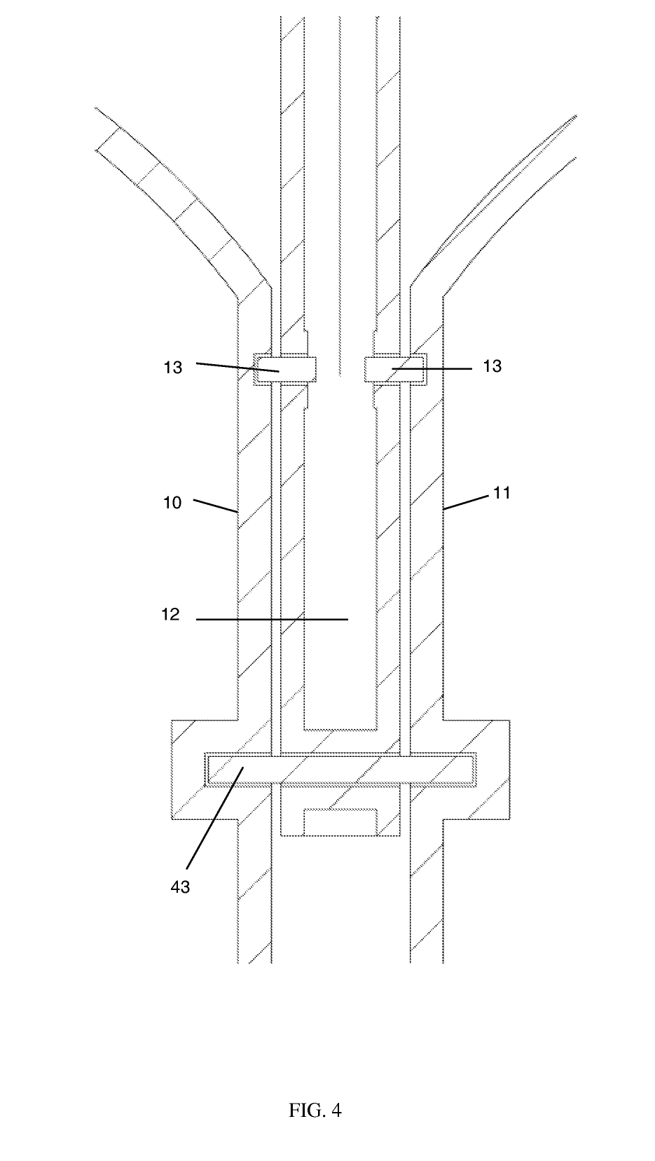

In FIG. 4, the pins (13) are shown engaged with the flat walls (10,11) of the first and second hollow bodies. The pins extend from the first hollow member (12). Reference number (43) shows a stub axle about which the first and second hollow bodies rotate, without the towing handle.

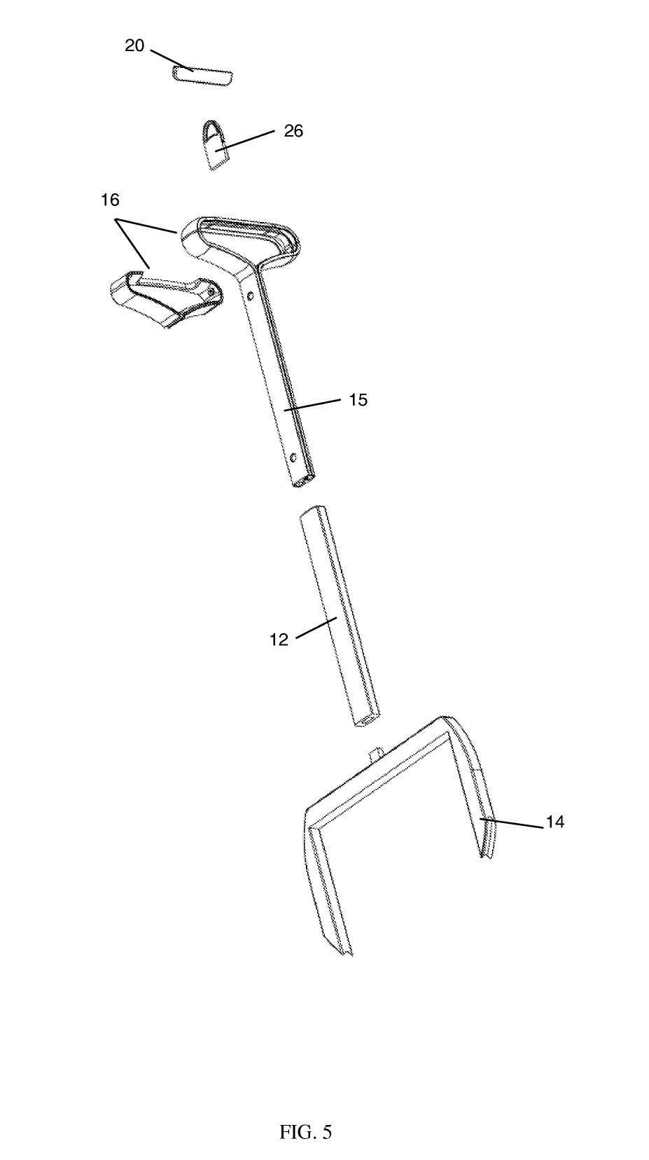

In FIG. 5, the towing handle comprises legs (14), a first hollow member (12), a second hollow member (15) and a handle portion (16). The dimensions of the second hollow member (15) are such that it is capable of sliding inside the first hollow member (12). The hollow members (12,15) in FIG. 5 have a rectangular cross section. This is not essential and in another embodiment they may have a square, circular or oval cross section. Reference number (26) represents a locking mechanism for locking the towing handle in the extended position.

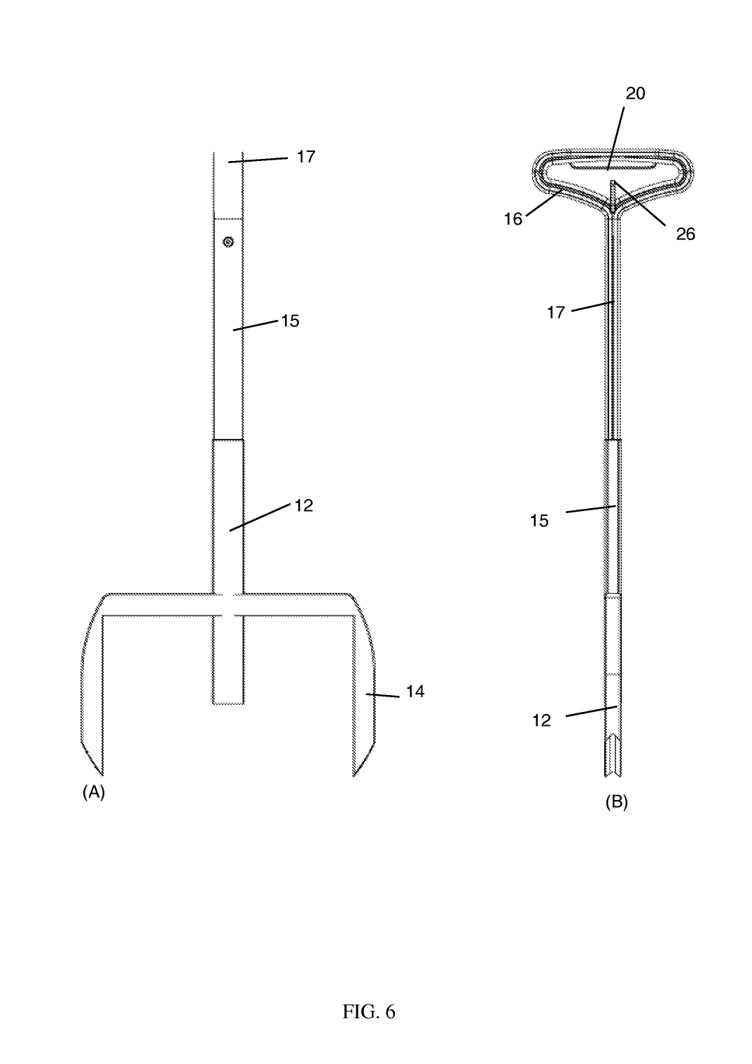

FIG. 6 (a) shows the legs (14), the first hollow member (12), the second hollow member (15) and a section of the third hollow member (17). FIG. 6 (b) shows a section of the first hollow member (12), the second hollow member (15) the third hollow member (17), and the handle portion (16).

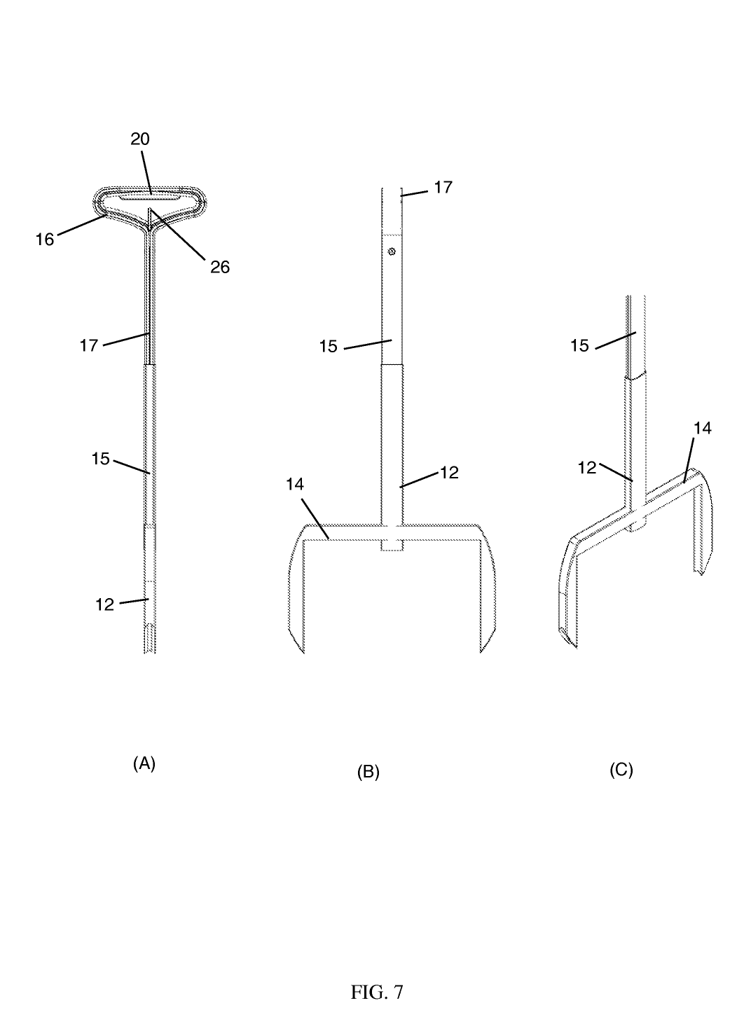

FIG. 7(a) shows a section of the first hollow member (12), the second hollow member (15) the third hollow member (17), and the handle portion (16). FIG. 7 (b) shows the legs (14), the first hollow member (12), the second hollow member (15) and a section of the third hollow member (17). FIG. 7 (c) shows the legs (14), the first hollow member (12), and a section of the second hollow member (15).

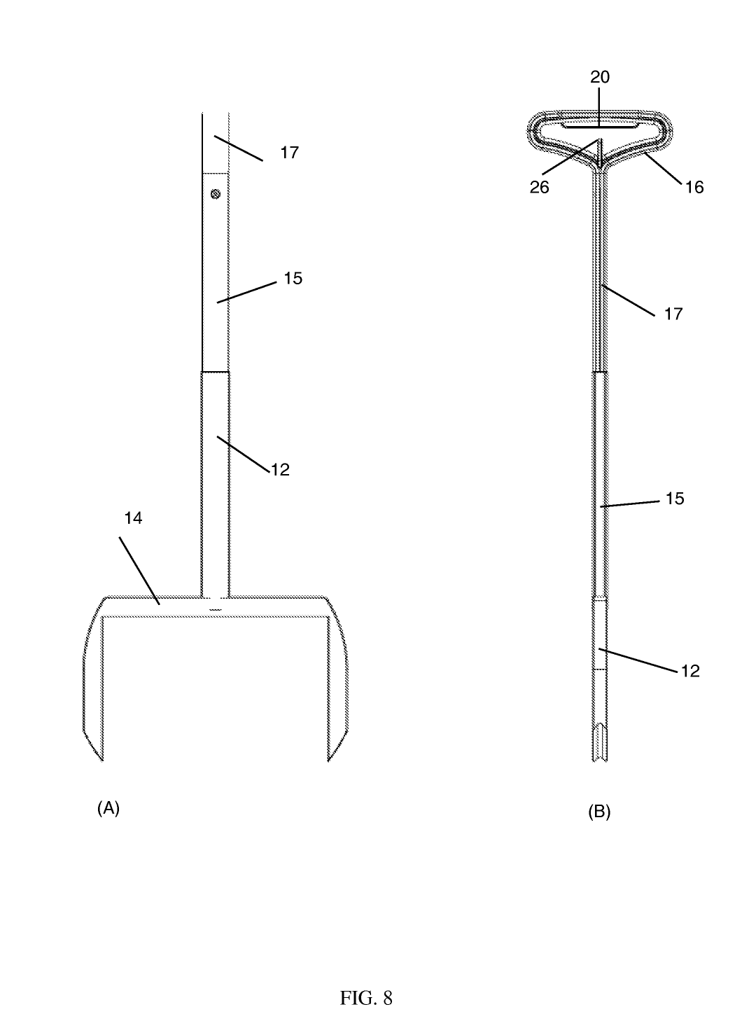

FIG. 8 (a) shows the legs (14), the first hollow member (12), the second hollow member (15) and a section of the third hollow member (17). FIG. 8(b) shows a section of the first hollow member (12), the second hollow member (15) the third hollow member (17), and the handle portion (16).

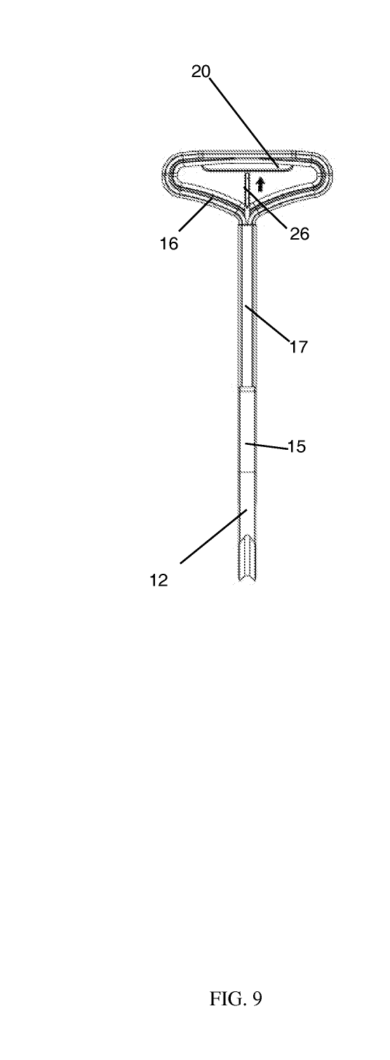

FIG. 9 shows a section of the first hollow member (12), the second hollow member (15) the third hollow member (17), and the handle portion (16). The control (20) for the lock is shown on the handle portion (16). The arrow indicates the direction of pressure that must be applied to the control to release the lock.

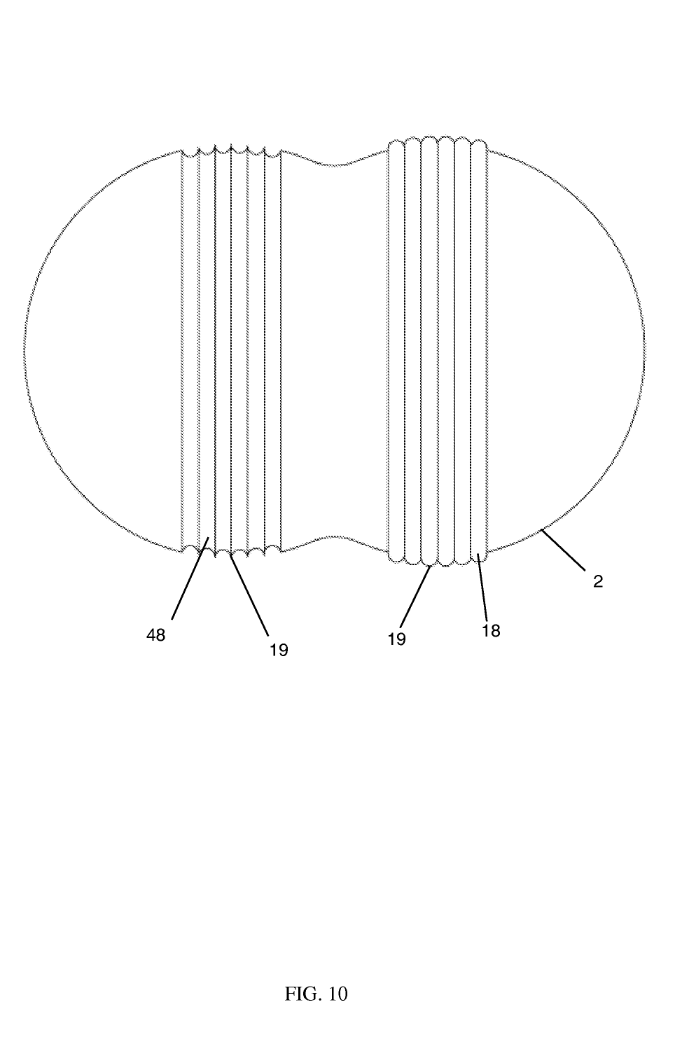

FIG. 10 shows the hollow body (2) with a plurality of hollow tubes (18) provided on the surface thereof in the regions of the points of ground contact (19). Reference number (48) shows the uneven surface of the hollow body, without the hollow tubes, in the region of one point of ground contact.

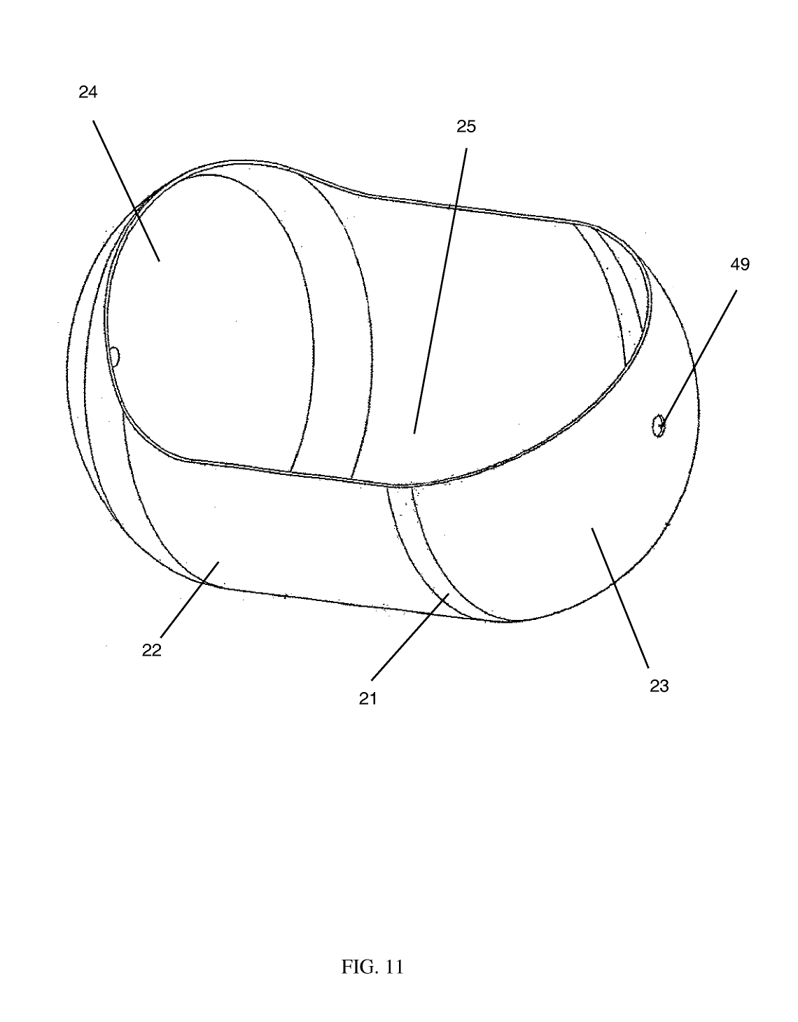

FIG. 11 shows an open-topped container (21) having curved side wall (22) and base (25) and curved end walls (23,24). Reference number (49) shows a recess for receiving a stub axle located on the hollow body, about which the hollow body can rotate whilst the container remains upright. In an alternative, the container could be provided with the stub axle and the hollow body with the recess.

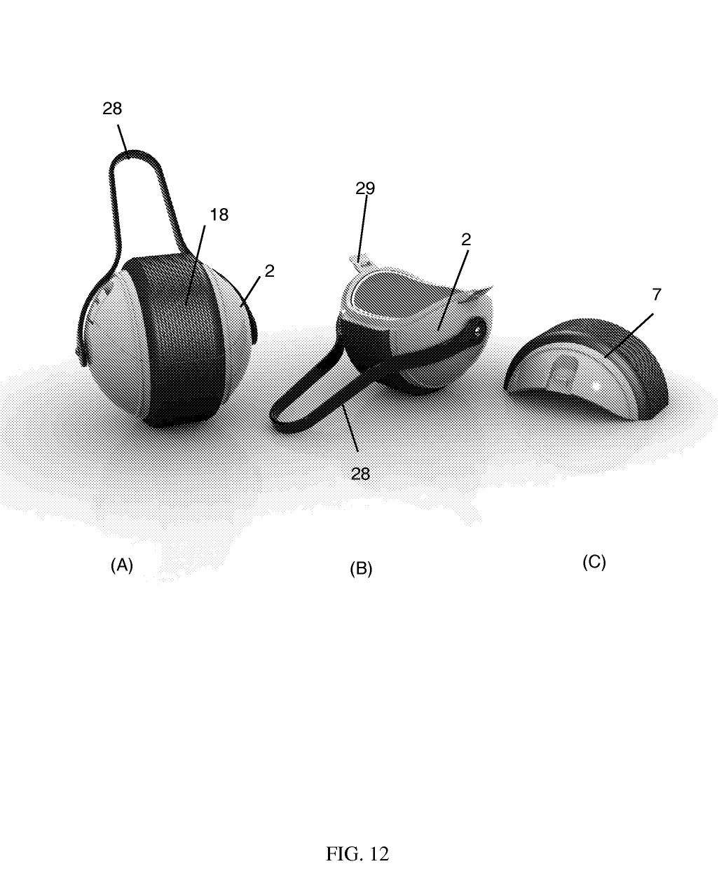

FIG. 12 shows the towing handle (28), which is attached to either side of the hollow body (2). The hollow body (2) has a moveable section (7) in the form of a lid. The lid is secured in its closed position by fastening means (29). The transport apparatus is provided with an uneven surface in the region of the point of ground contact in the form of a layer of ribbed absorbing material (18), which extends around the hollow body.

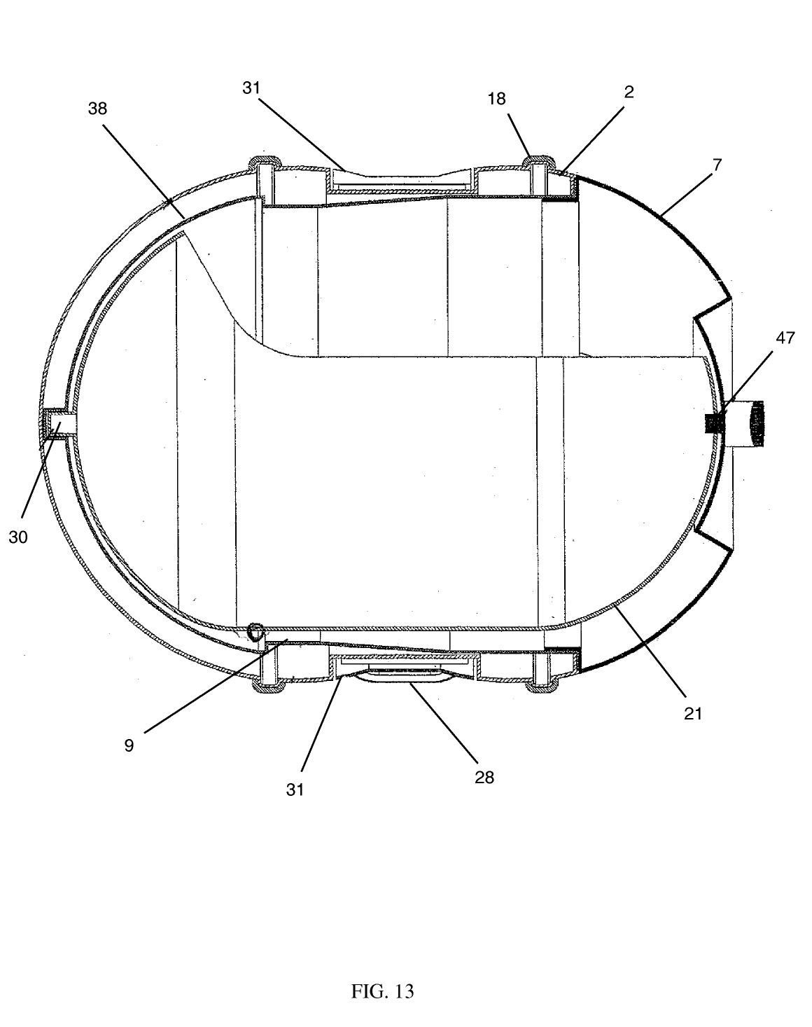

FIG. 13 shows a cross section of transport apparatus with a telescopic towing handle (28) in the folded position. The cradle shaped container (21) is shown with stub axle (30) engaged with the inner wall (38) of the hollow body (2). The hollow body has a moveable section (7) and a central member (31). A layer of ribbed material (18) is provided in the regions of each of the two points of ground contact. A stub axle (48) extends from the hollow body into a recess in the container wall, about which the hollow body can rotate whilst the container remains upright. The inner wall (38) comprises a sloped guiding wall (9) so that the container is self-locating when it is inserted into the hollow body. The guiding wall (9) raises the container to engage the stub axle (30). The container (21) is in its fully inserted position and thus there is a gap between the container and the inner wall (38) of the hollow body to allow free rotation of hollow body around the container.

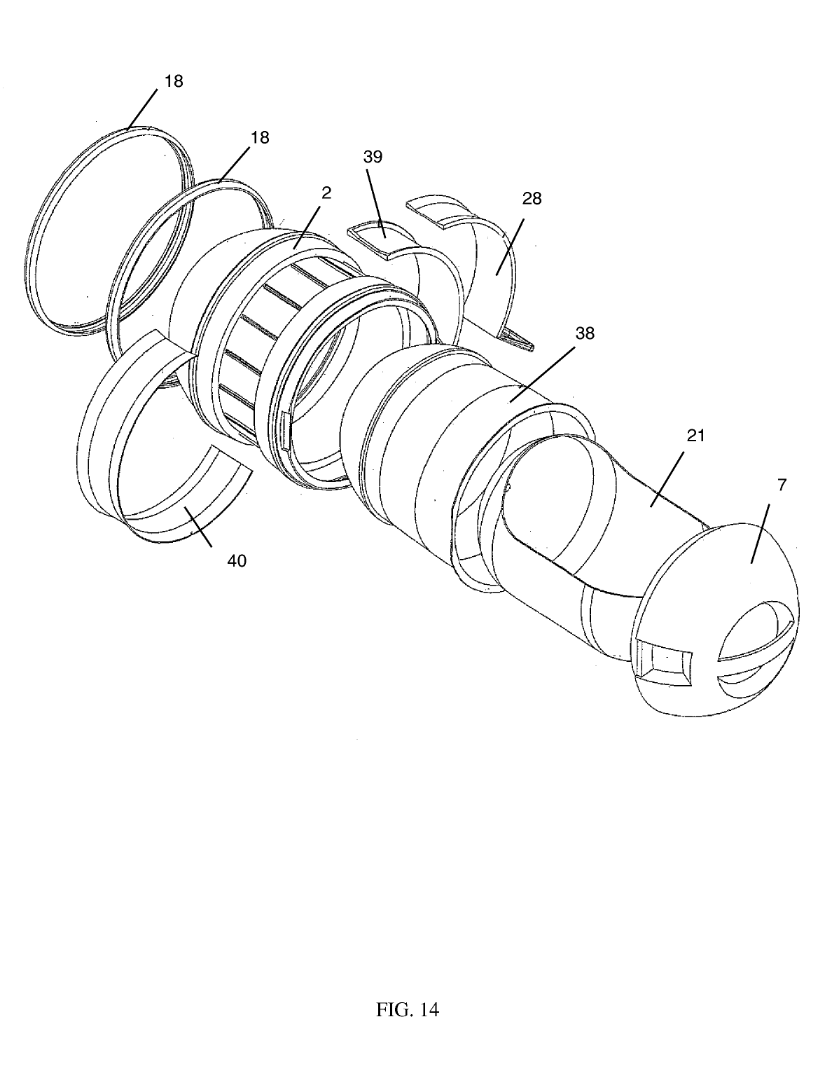

FIG. 14 shows the moveable section (7), the cradle shaped container (21), the inner wall of the hollow body (38), the outer wall of the hollow body (2) and layers of ribbed material (18). The towing handle (28) is also shown. Reference numbers 39 and 40 together refer to the tubular portion, which forms a wall around the outside of the central member of the hollow body.

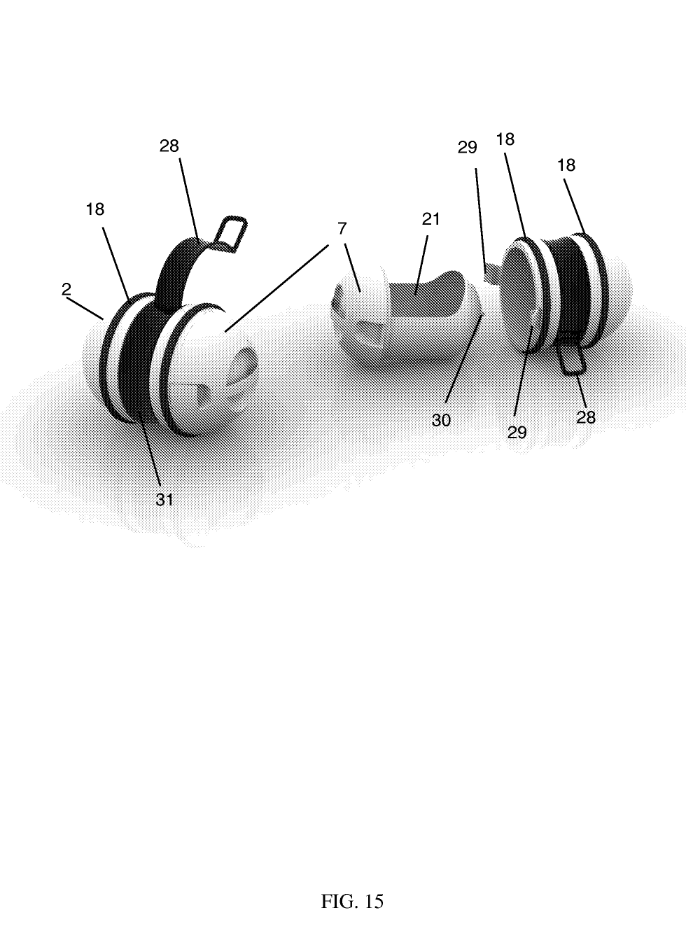

FIG. 15 shows the moveable section (7), the cradle shaped container (21), the central member (31), the hollow body (2) and layers of ribbed material (18). Moveable section (7) will be rotatable with respect to the container (21). The towing handle (28) is also shown and fastening means (29) are shown for fastening the moveable section in the closed position. Reference number (30) shows a stub axle extending from the container.

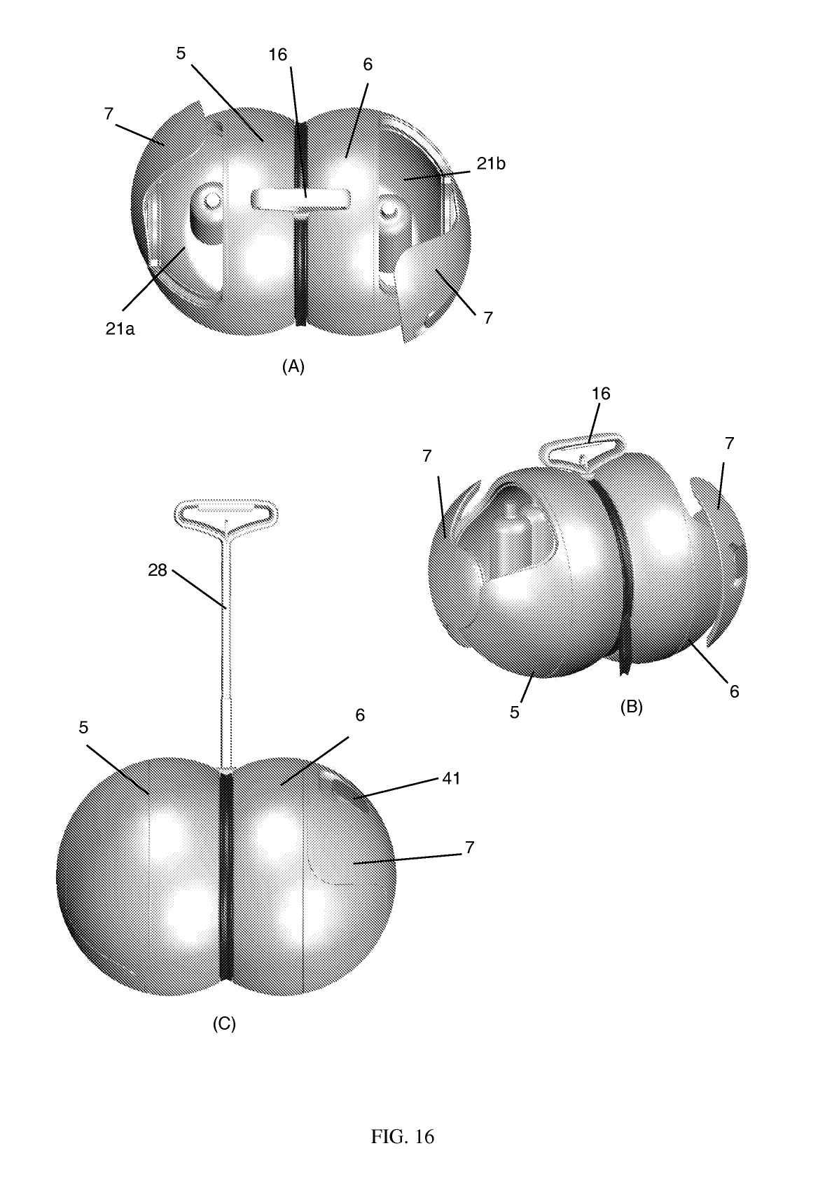

FIG. 16 shows the moveable sections (7) in the form of nesting lids, the cradle shaped containers (21a and b), the first body (5) and the second body (6). The telescopic towing handle (28), including a handle portion (16), is also shown and handle (41) to assist in opening the moveable sections is shown. Figures a and b show the moveable section in their open positions and Figure c shows the moveable sections in their closed positions. Figure b shows the towing handle in the folded position and Figure c shows the extended position.

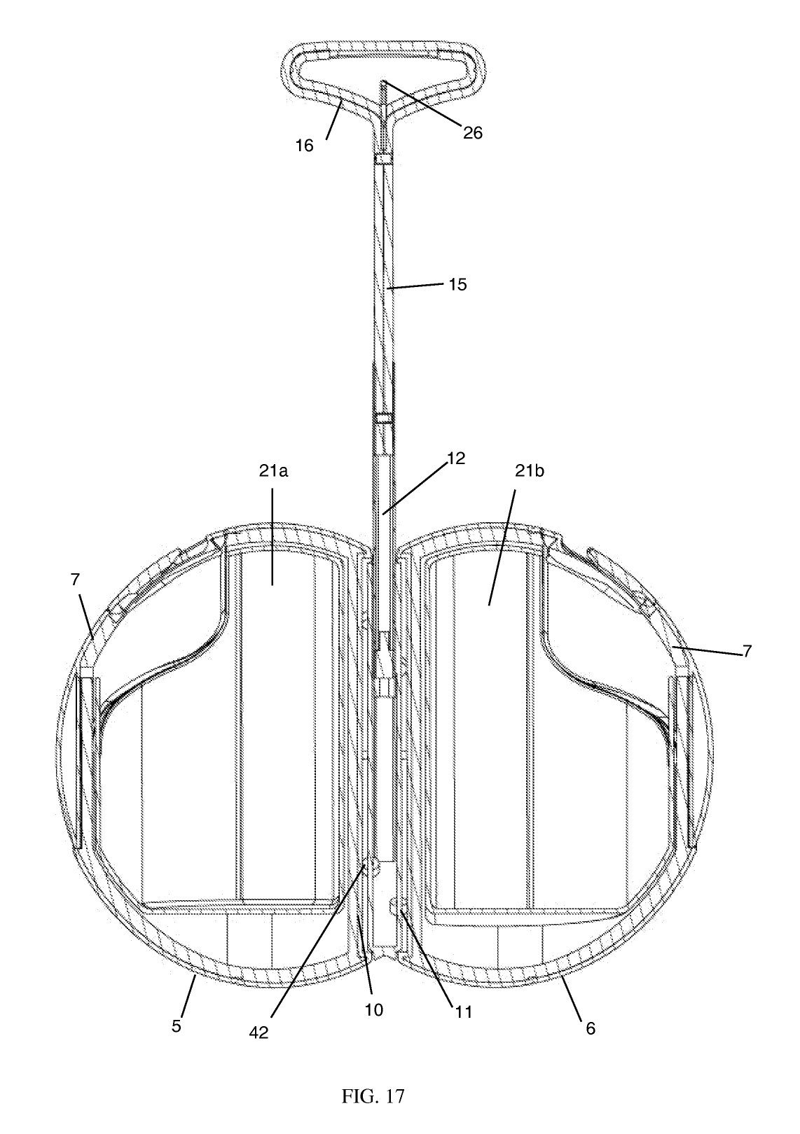

FIG. 17 shows the moveable sections (7) in the form of nesting lids, the cradle shaped containers (21a and b), the first body (5) and the second body (6). The telescopic towing handle comprises a handle portion (16), a second hollow member (15) and a first hollow member (12). The flat wall of the first body (10) and the flat wall of the second body (11) are also shown engaged with jockey wheels (42) of the central member. The first hollow member (12) is located between the flat wall of the first body (10) and the flat wall of the second body (11). Reference number (26) refers to the locking mechanism for keeping the towing handle in the extended position.

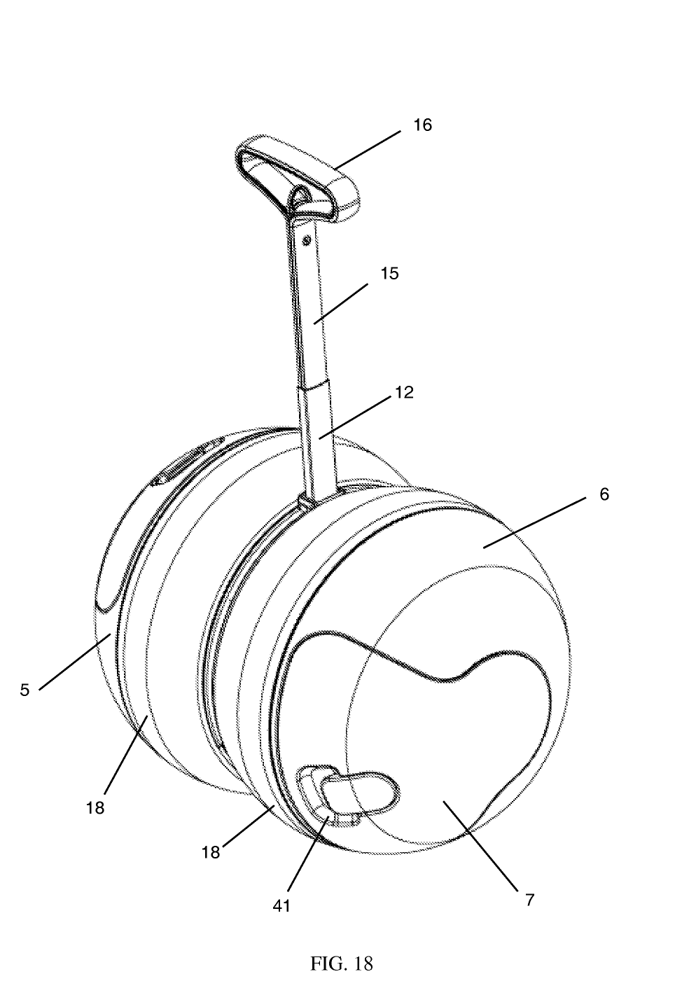

FIG. 18 shows the first body (5) and the second body (6), and the moveable sections (7) in the form of nesting lids, with the handle of the second body (41). The telescopic towing handle comprises a handle portion (16), a second hollow member (15) and a first hollow member (12). A layer of ribbed absorbing material (18) is provided in the regions of each of the two points of ground contact.

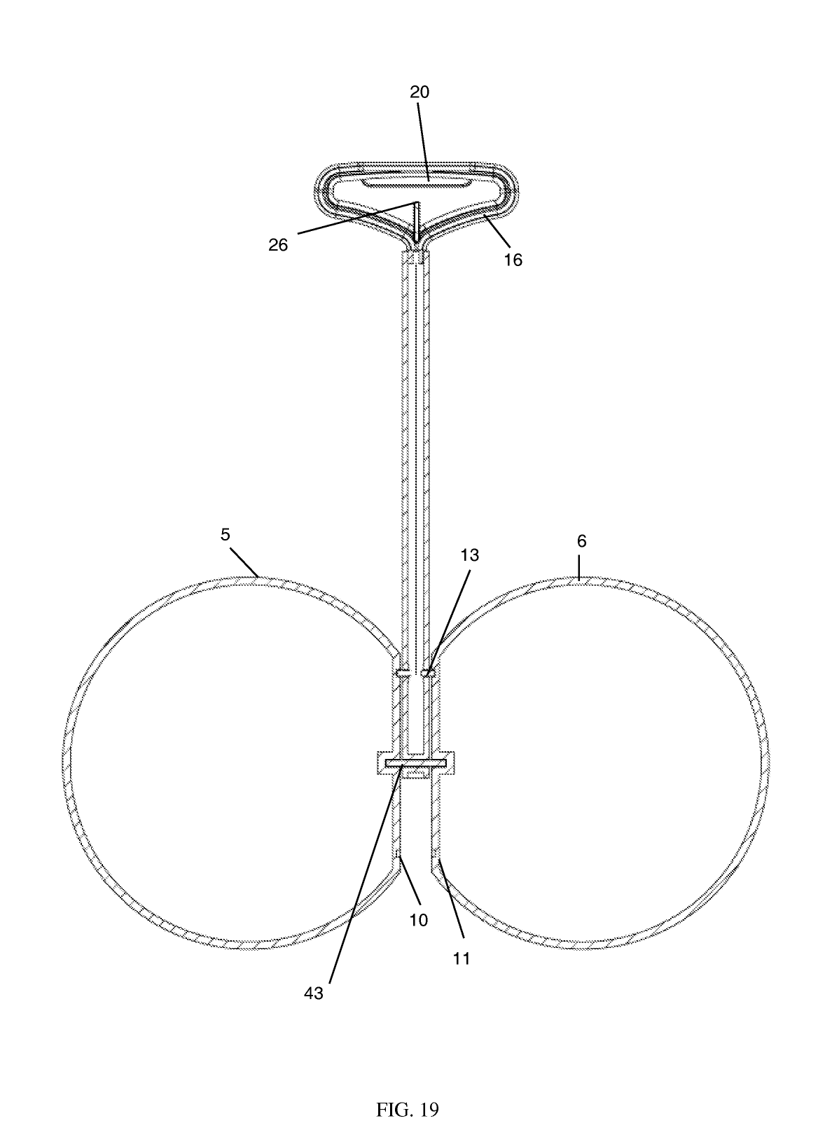

FIG. 19 shows the first body (5) and the second body (6), and a telescopic towing handle comprises a handle portion (16) having a control (20) for controlling the first and second pins (13), which are shown engaged with the flat walls (10,11) of the first and second bodies. A stub axle (43), which extends into the first and second bodies, holds the towing handle in position and allows the first and second bodies to rotate around it.

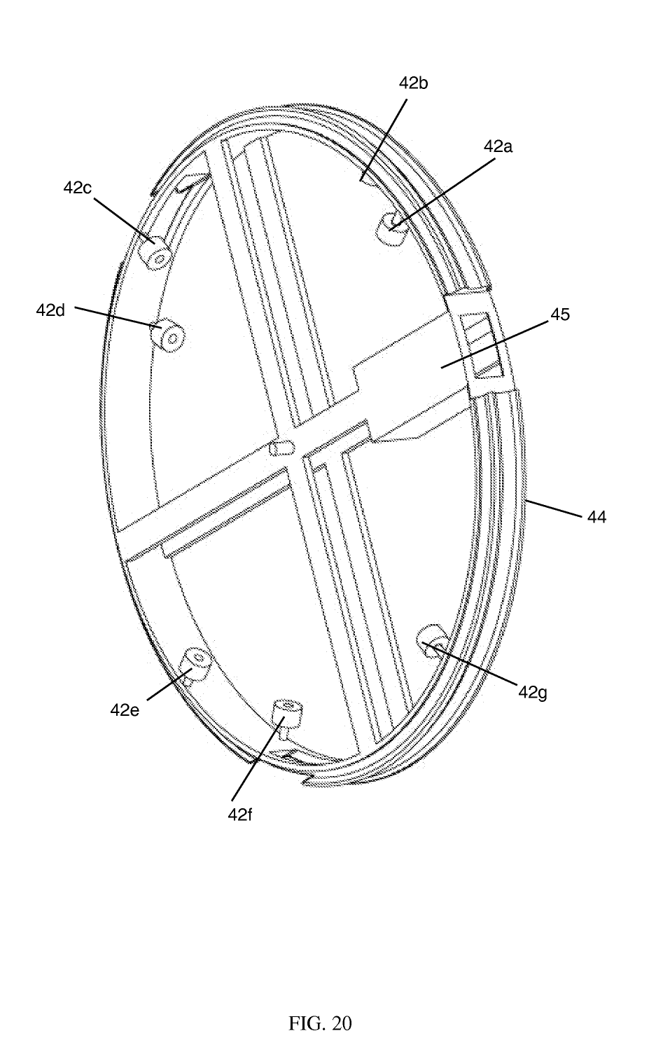

FIG. 20 shows a perspective view of the inside of the substantially tubular central member, having two sets of jockey wheels (42a,c,e,g and 42b,d,f). Reference (45) shows the housing for first hollow member of the towing handle (not shown).

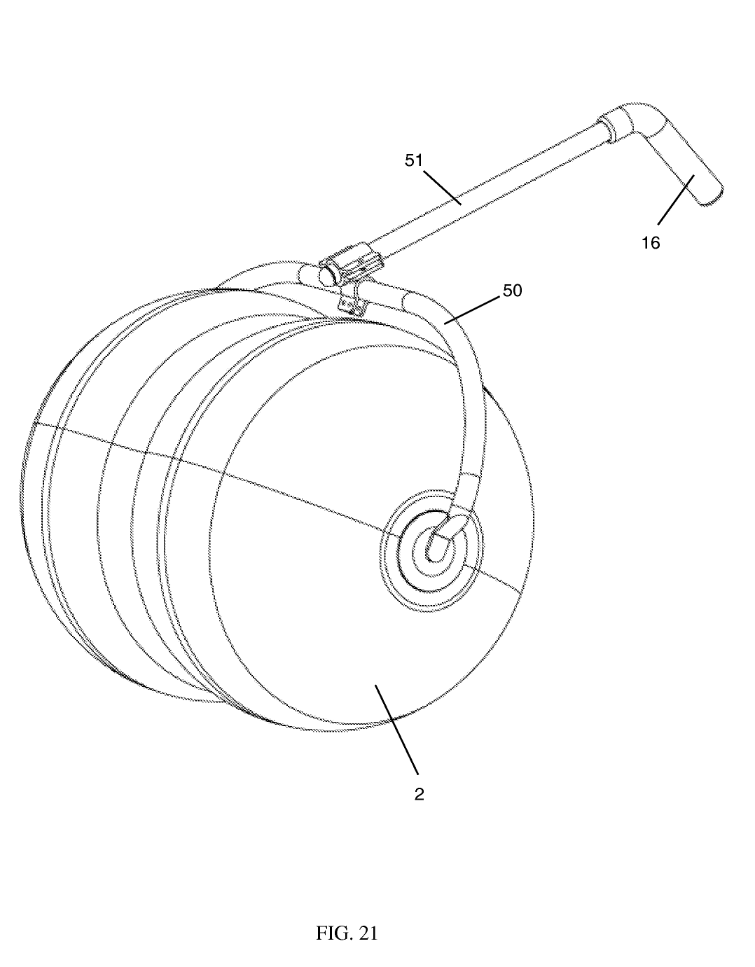

In FIG. 21, the U-shaped portion (50) is attached at its ends to the hollow body (2). The towing handle has an elongated portion that is detachable.

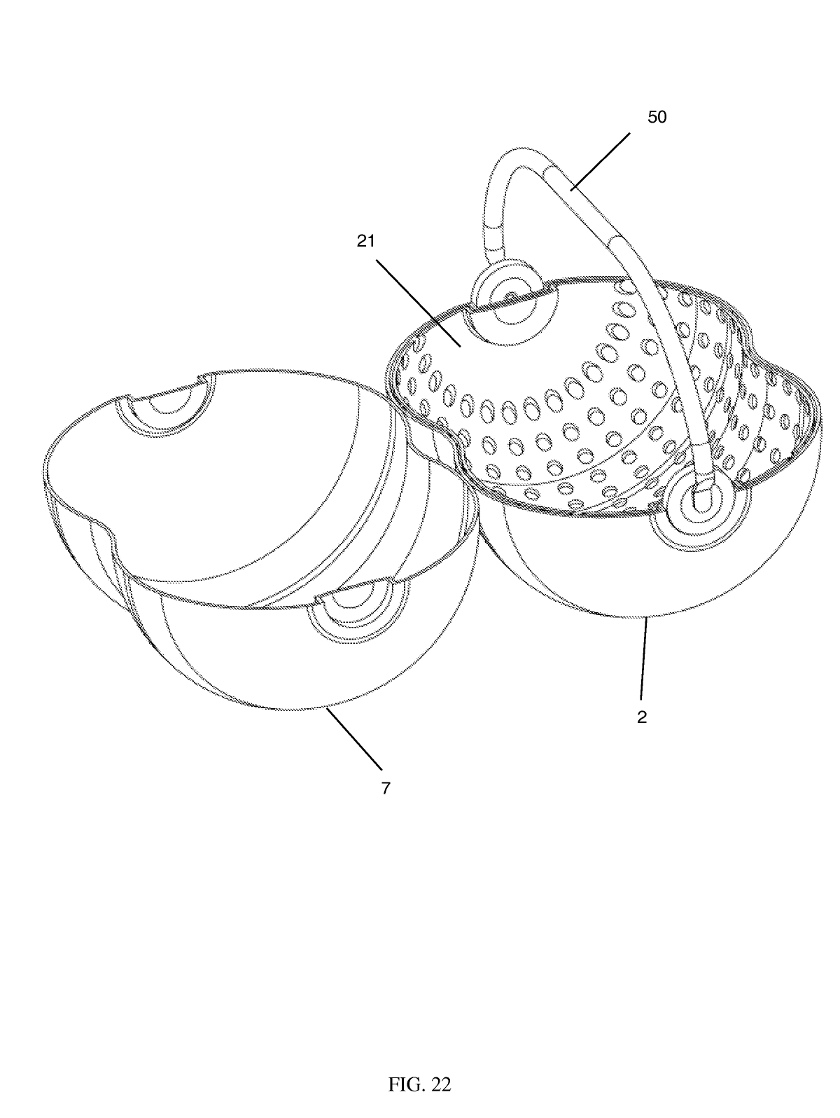

In FIG. 22, the elongated portion (not shown) of the towing handle has been removed from the U-shaped portion and the U-shaped portion acts as a carrying handle. The moveable section (7) of the hollow body is in the open position and the container (21) can be accessed whilst it remains housed inside the hollow body (2).

What is claimed is:

1. Transport apparatus comprising a hollow body; a towing handle; and a container housed within the hollow body, whereby the hollow body is rotatable so as to enable the transport apparatus to be rolled along a surface when a force is applied to the towing handle, the hollow body having two points of contact with the surface, wherein the cross section of the hollow body at the points of contact is circular and the container is mounted on an axis such that it remains upright even when the hollow body is rotating.

2. Transport apparatus according to claim 1, wherein the hollow body comprises a first body and a second body where the first body is joined to the second body via a central member.

3. Transport apparatus according to claim 2, wherein the first body and the second body each comprise more than half of an ovoid or sphere and the central member is substantially tubular.

4. Transport apparatus according to claim 2, wherein the first body comprises a first moveable section and the second body comprises a second moveable section.

5. Transport apparatus according to claim 4, wherein the first moveable section is located on one side of the hollow body and comprises a first nesting lid and the second moveable section is located on the opposing side of the hollow body and comprises a second nesting lid.

6. Transport apparatus according to claim 4, wherein the first hollow body defines a first storage area and the second hollow body defines a second storage area that is separate from the first storage area.

7. Transport apparatus according to claim 6, wherein the first body and the second body each comprise more than half of an ovoid or sphere and a flat wall to close the ovoid/sphere.

8. Transport apparatus according to claim 7, wherein the central member comprises first and second sets of jockey wheels and the flat wall of the first body engages with the first set of jockey wheels and the flat wall of the second body engages with the second set of jockey wheels.

9. Transport apparatus according to claim 4, wherein the towing handle is mounted to the central member, between the first body and the second body, and the towing handle is extendable telescopically between a first extended position for pulling or pushing the transport apparatus and a second folded position for carrying or storing the apparatus.

10. Transport apparatus according to claim 2, wherein the hollow body comprises a single moveable section.

11. Transport apparatus according to claim 10, wherein the walls of the hollow body define a single storage area.

12. Transport apparatus according to claim 11, wherein the first body and the second body each comprise more than half of an open-ended ovoid or sphere.

13. Transport apparatus according to claim 11, wherein the container is at least partially removable from the hollow body and the moveable section is located on the side of the hollow body and the container comprises the moveable section.

14. Transport apparatus according to claim 13, wherein the base of the container is substantially flat and is provided with a jockey wheel and wherein a guiding wall is provided inside the hollow body across which the jockey wheel rolls when the container is inserted inside the hollow body.

15. Transport apparatus according to claim 10, wherein the towing handle is moveable between a first extended position for pulling or pushing the transport apparatus and a second folded position for carrying or storing the apparatus, wherein the towing handle comprises a rigid, curved portion and a handle portion, wherein one end of the curved portion is rotatably fixed to the central member and the handle portion is fixed to the other end of the curved portion

16. Transport apparatus according to claim 1, wherein absorbing material is provided on an outer surface of the hollow body at each point of contact.

17. Transport apparatus according to claim 1, wherein the towing handle is provided with a control for a brake, wherein when the brake is engaged, the hollow body is prevented from rotating and when the brake is disengaged, the hollow body is free to rotate.

18. Transport apparatus according to claim 1, wherein the apparatus is further provided with legs moveable between a first position and a second position.

19. Transport apparatus according to claim 1, wherein the hollow body comprises an inner wall and an outer wall.

20. Transport apparatus according to claim 1, wherein an outer surface of the transport apparatus is uneven in the region of the one or two points of contact.

21. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that absorbing material is provided on the outer surface of the hollow body at the or each point of contact.

22. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the towing handle is provided with a control for a brake, wherein when the brake is engaged, the hollow body is prevented from rotating and when the brake is disengaged, the hollow body is free to rotate.

23. Transport apparatus according to claim 22, wherein the towing handle is extendable telescopically between a first extended position for pulling or pushing the transport apparatus and a second folded position for carrying or storing the apparatus.

24. Transport apparatus according to claim 22, wherein the lock comprises a first pin and a second pin, the first and second pins being moveable together between a first position and a second position.

25. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the apparatus is further provided with legs moveable between a first position and a second position.

26. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the hollow body comprises an inner wall and an outer wall.

27. Transport apparatus according to claim 26, wherein the cavity between the inner wall and the outer wall is filled with an insulating material.

28. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the outer surface of the transport apparatus is uneven in the region of the one or two points of contact.

29. Transport apparatus according to claim 28, wherein absorbing material is provided on the uneven surface.

30. Transport apparatus according to claim 29, wherein the absorbing material comprises a plurality of hollow tubes.

31. Transport apparatus according to claim 28, wherein the transport apparatus has a single point of ground contact and the hollow body comprises first and second bodies each being substantially hemispherical, the first and second bodies being joined by a central member that is substantially tubular.

32. Transport apparatus according to claim 31, wherein the hollow body has a single moveable section in the form of a removable lid.

33. Transport apparatus according to claim 31, wherein the towing handle is attached to both sides of the hollow body.

34. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the towing handle comprises a substantially U-shaped portion, which is attached at its two ends to the hollow body, and an elongated portion, which extends from the U-shaped portion, the elongated portion being detachable from the U-shaped portion and comprising a handle portion for grasping to pull or push the transport apparatus.

35. Transport apparatus according to claim 34, wherein all external mating edges in the transport apparatus are provided with a water tight and/or air tight seal.

36. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that all external mating edges in the transport apparatus are provided with a seal so as to render the transport apparatus air tight and/or water tight.

37. Transport apparatus comprising a hollow body; a towing handle; and a container housed inside the hollow body, wherein the hollow body has one or two points of contact with a flat surface such as the ground when the body is resting on the flat surface and wherein the hollow body is rotatable so that the transport apparatus can roll along a flat surface such as the ground when a force is applied to the towing handle, the cross section of the hollow body at the or each point of contact being circular and the container being mounted on an axis such that the container remains upright even when the hollow body is rotating; characterised in that the container comprises a plurality if sub-containers specifically adapted to fit together so as to be suitable to be housed inside the hollow body and wherein the container is provided with a pair of opposing stub axles or a pair of opposing recesses or one stub axle and one opposing recess so as to be suitable to be mounted on an axis such that the container remains upright even when the hollow body is rotating.
